(19) United States
(12) Patent Application Publication
(10) Pub. No.: US 2004/0000322 A1
(43) Pub. Date: Jan. 1, 2004

(54) Point-of-use mixing with H2SO4 and H2O2 on top of a horizontally spinning wafer

(75) Inventor: Steven Verhaverbeke, San Francisco, CA (US)

Correspondence Address: PATENT COUNSEL, APPLIED MATERIALS, INC., Legal Affairs Department, P.O. Box 450A, Santa Clara, CA, 95052, US

(73) Assignee: Applied Materials, Inc.

(21) Appl. No.: 10/187,571

(22) Filed: Jul. 1, 2002

(51) Int. Cl. B08B 3/02

(52) U.S. Cl. 134/1.3; 134/33; 134/902; 134/36; 134/21; 134/30; 134/153

(57) ABSTRACT

A method of stripping photoresist from a single wafer that includes flowing H2SO4 toward a top surface of the wafer and flowing H2O2 toward the top surface of the wafer where the H2SO4 reaches a first location and the H2O2 reaches a second location.

### FIELD OF THE INVENTION

The present invention pertains in general to wafer processing and in particular to a single wafer photoresist stripping process.

### BACKGROUND OF THE INVENTION

One of the most important tasks in semiconductor industry is the cleaning and preparation of the silicon surface for further processing. Modern integrated electronics would not be possible without the development of technologies for coating removal, cleaning and contamination control, and further reduction of the contamination level of the silicon wafer is mandatory for the further reduction of the IC element dimensions. Wafer stripping and cleaning is the most frequently repeated operation in IC manufacturing and is one of the most important segments in the semiconductor-equipment business, and it looks as if it will remain that way for some time. Each time device-feature sizes shrink or new tools and materials enter the fabrication process, the task of stripping and cleaning gets more complicated.

Modern semiconductor technology makes use of photoresist coatings to act as a mask for patterns etched into the substrate material. An important goal is the removal of these in-process coatings and contaminants from the wafer surface. Photoresist stripping historically has been completed with inorganic oxidizing mixtures where inorganic acids such as sulfuric acid (H2SO4), nitric acid (HNO3), chromic acid (H2CrO4), phosphoric acid (H3PO4), and hydrogen peroxide (H2O2) have been used to strip resist layers. In addition, Piranha baths, composed of sulfuric acid mixed with hydrogen peroxide have been widely used with post-ash resist stripping within the industry. The bulk of resist coatings are removed by ashing the photoresist and as a result, wet photoresist stripping has been mainly limited to post-ash resist stripping.

Megasonic agitation is the most widely used approach to adding energy (at about 800 kHz or greater) to the wet cleaning process. The physics behind how materials such as photoresist layers and particles are removed, however, is not well understood. A combination of an induced flow in the cleaning solution (called acoustic streaming), cavitation, the level of dissolved gases, and oscillatory effects are all thought to contribute to cleaning performance.

### SUMMARY OF THE INVENTION

The present invention is an apparatus for improved photoresist stripping in a single wafer cleaning chamber. In one embodiment, H2SO4 is applied onto a wafer surface with a first nozzle and H2O2 is applied onto the wafer surface by a second nozzle such that the mixing occurs on the wafer surface. As a result, heat is not generated in tubing or valve structures from the heat of mixing of the two chemicals, but rather is generated on the wafer surface where the elevated temperatures can improve the cleaning process.

In an alternate embodiment, the H2SO4 and the H2O2 are mixed by combining the two fluid streams from the first and second nozzles above the wafer surface and further where the H2O2 can be applied as a vapor that has been created by bubbling an inert gas through an H2O2 solution.

### BRIEF DESCRIPTION OF THE DRAWINGS

The present invention is illustrated by way of example and not limitation in the figures of the accompanying drawings, in which like references indicate similar elements and in which:

FIG. 1 is an illustration of an embodiment of a single wafer process chamber with point of use mixing.

FIG. 2A is an illustration of one embodiment of two nozzles for point-of-use mixing.

FIG. 2B is an illustration of an alternate embodiment of point-of-use mixing by two angled nozzles.

FIG. 2C is an illustration of another alternate embodiment of point-of-use mixing by two nozzles.

FIG. 2D is an illustration of a top view of the another alternate embodiment of point-of-use mixing by two nozzles.

FIG. 2E is an illustration of one embodiment of point-of-use mixing by two nozzles that occurs above the wafer.

FIG. 3 is an illustration of another embodiment of a single wafer cleaning chamber with point-of-use mixing.

FIG. 4 is a flow-chart of one embodiment of a method for point of use mixing.

FIG. 5 is a flow-chart of another embodiment of a method for point of use mixing.

### DETAILED DESCRIPTION

For purposes of discussing the invention, it is to be understood that various terms are used by those knowledgeable in the art to describe apparatus, techniques, and approaches. In the following description, for purposes of explanation, numerous specific details are set forth in order to provide a thorough understanding of the present invention. It will be evident, however, to one skilled in the art that the present invention may be practiced without these specific details. In some instances, well-known structures and devices are shown in gross form rather than in detail in order to avoid obscuring the present invention. These embodiments are described in sufficient detail to enable those skilled in the art to practice the invention, and it is to be understood that other embodiments may be utilized and that logical, mechanical, chemical, and other changes may be made without departing from the scope of the present invention.

In the present invention, a method and apparatus for enhancing the cleaning operation on a wafer in a single wafer cleaning chamber is disclosed. In one aspect of the present invention, a cleaning solution is formulated in such a way as to increase the efficiency of the cleaning apparatus. This aspect of the present invention can combine H2SO4 with H2O2 to form a photoresist stripping solution under conditions that otherwise would add cost and complexity to the single wafer cleaning chamber. To limit the cleaning chamber complexity, the chemicals can be combined at the point of use, i.e. the chemicals can be applied separately to mix on the wafer top surface or to mix just above the wafer top surface. During the time that the photoresist stripping solution is on the wafer top surface, the wafer can be rotated and megasonic energy can be applied to the wafer bottom surface. The addition of megasonic energy can reduce the time required for the photoresist stripping process. The mixed chemicals after application onto the wafer can be discarded after a single use.

The wafer photoresist stripping solution of the present invention can consist of a mixture of sulfuric acid (H2SO4) and hydrogen peroxide (H2O2). After a pattern etching process has been accomplished, a wafer can be placed into the single wafer cleaning chamber with the wafer positioned to have the photoresist coating facing up, i.e. the top surface. The solution for stripping the photoresist can be mixed within the single wafer cleaning chamber, i.e. at point of use, and the stripping solution applied to the wafer top surface. In one embodiment of point of use mixing, the stripping solution can be made by mixing a first fluid stream of H2O2 passing out a first nozzle with a second fluid stream of H2SO4 passing out a second nozzle where the two chemicals can be combined by impinging the two streams just above the wafer top surface. After impinging, the combined stream can then contact the top surface of the wafer at a location, such as, for example, at the wafer center of rotation. In an alternate embodiment, the two fluid streams can impinge to mix at a location on the wafer top surface.

In either case, heat produced from the heat of mixing H2O2 with H2SO4 will not have time to degrade the H2O2. As a result, the H2O2 can be stored and applied at ambient or slightly elevated temperatures to further limit the loss in oxidative power in H2O2 since H2O2 can degrade at high temperatures. The heat of mixing that results when dilute H2O2 and concentrated H2SO4 are combined can be useful when such heat is generated on the wafer since heat can improve the oxidation process in removing the photoresist. In addition, since heat of mixing will not occur within the single wafer cleaning chamber apparatus, there will not be any heat degradation of the interconnecting tubing and valves associated with transferring the H2SO4 and H2O2 chemistry into the single wafer process chamber.

Mixing H2SO4 and H2O2 creates Caro's acid (H2SO5) and H2O as products where the reaction proceeds as follows:

H2O2+H2SO4 HO—(SO2)-O—OH+H2O [1]

Caro's acid is the active species in Piranha baths and where concentrated sulfuric acid is an excellent solvent for Caro's acid, Caro's acid decomposes in water. The reaction [1] shows that H2O is produced in the reaction of H2O2 and H2SO4 , and therefore, since the reaction is reversible, an increasing presence of water can actually shift the reaction back towards the reactants, minimizing the production of Caro's acid. Mixing at point-of-use, and then quickly removing the mixture by rotating wafer in the single wafer cleaning chamber, can limit increasing H2O concentrations and minimize any reversal of the reaction of H2SO4 with H2O2.

As a result of the rapid use of the H2SO4/H2O2 stripping solution after mixing, i.e. mixing occurs on or just above the wafer, and the discard of the mixture after one use on a single wafer, problems previously associated with the use of Caro's acid can be reduced or eliminated. Such previous problems included the need for subsequent replenishment of thermally degraded H2O2 from the heat of mixing with H2SO4. In addition, since H2SO5 is not particularly heat-stable either, the heat of mixing also lead to thermal decomposition of the H2SO5. And finally, the addition of H2O (as part of the dilute H2O2) in addition to the H2O product from the reaction [1] (above), would drive the reaction further towards the reactants.

Single wafer stripping and cleaning has intrinsic advantages over conventional batch type of stripping/cleaning. It can be used in applications with critical timing constraints between process steps and pre- or post cleaning. In addition, single wafer stripping/cleaning can allow for better access to the wafer allowing for more optimized cleaning methods. Single wafer stripping/cleaning can also enable the integration of the stripping/cleaning step inside cluster tools leading to increased performance and reduced cycle time. In addition to photoresist removal, a single wafer cleaning chamber can be used to clean wafers before and after a variety of wafer processes, such as, for example, deposition of a metallized film, or Rapid Thermal Processes where RTP can be used for such process as wafer annealing, doping, and oxide growth.

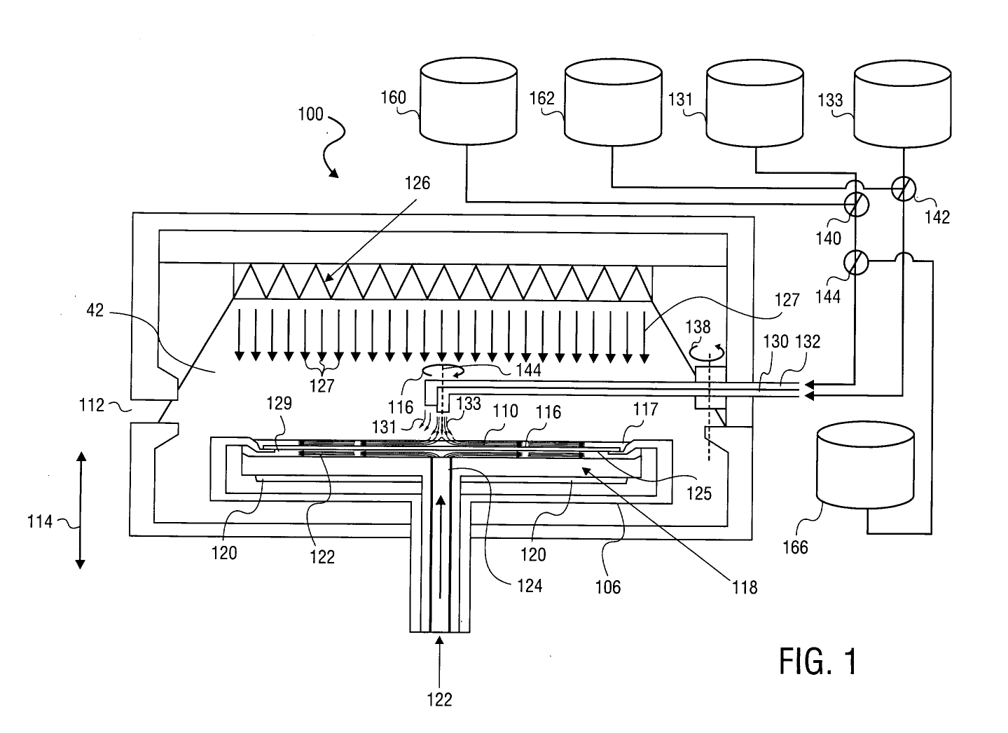

FIG. 1 is an illustration of one embodiment of a single wafer cleaning chamber. As shown in FIG. 1, a single wafer cleaning chamber 100 can contain a rotatable 116 and translatable 114 wafer holding bracket 106. A robot arm (not shown) holding a wafer 110 can enter the chamber 100 through a wafer transfer slit 112. The arm can place the wafer 110 onto the bracket 106 where the bracket 106 is elevated to receive the wafer 110. Raising the bracket 106 can keep the wafer 110 and robot arm clear of other components during the transfer. The wafer 110 can be maintained in position on the bracket 106 by such forces as gravity, the flow of chemicals, and the downward flow of air 127 from an air filter 126.

Once the wafer 110 is placed onto the bracket 106, the bracket 106 can be lowered to a process position as shown. This process position can create a gap 129 by placing the wafer 110 a short distance above a circular plate 118. The circular plate 118 can be made of a sapphire ceramic or from such metals as, for example, stainless steel or aluminum. Transducers 120 capable of emitting sound in the megasonic frequency range can be bonded to the bottom side of the circular plate 118 and where the remaining exposed surfaces of the circular plate 118 can, if needed, be covered with a protective coating such as a fluoropolymer.

A fluid feed port 124 can be added to the transducer plate 118 to fill the approximate 3 millimeter (mm) gap 129 between the transducer plate 118 and the wafer 110 with a liquid 122 at various times during wafer 110 processing. The liquid 122, such as, for example, deionized water, can act as a carrier for transferring megasonic energy from the circular plate 118 onto the wafer bottom surface 125. In addition, the liquid 122 can be heated, such as, for example, to a temperature of 90 - degrees C., so as to heat the wafer 110. The top of the single wafer cleaning chamber 100 can contain the filter 126 to clean air flowing 127 into the process chamber 100 and onto a top surface 116 of the wafer 110.

Two nozzles 130 and 132 can be positioned in the single wafer cleaning chamber 100. The two nozzles 130 and 132 can be positioned over the top of the wafer 110 to flow chemicals 131 and 133 onto the wafer top surface 116 during a photoresist stripping operation. In one embodiment, the two nozzles 130 and 132 can be used to separately flow H2SO4 131 and H2O2 (133) onto the wafer 110. The two nozzles 130 and 132 can be fixedly attached to each other such that they can pivot 138 in unison. The two nozzles 130 and 132 can be positioned during the flow of chemicals 131 and 133 for example, at or near the wafer center (i.e. the center of rotation 144 of the wafer 110).

Megasonic waves acting through the DI water in the gap 129 can enhance the photoresist stripping operation on the wafer top surface 116. For optimal wafer 110 throughput, the total area of the acoustic wave transducers 120 can be sufficient to provide approximately between 80-100% area coverage of the circular plate 118. The circular plate 118 diameter may be approximately the same size or larger than the wafer diameter 117. The invention is scalable to operate on a wafer 110 that is 200 mm (diameter), 300 mm (diameter), or larger in size. If the wafer diameter is larger than the circular plate 118 diameter, the vibrations from the megasonic energy striking the wafer 110 can still travel to the wafer 110 outer diameter (OD) 117 providing full coverage for the stripping action.

During the stripping operation, the wafer 110 can be rotated at a selected revolution per minute (rpm) about the wafer axis of rotation 116 that also is the bracket 106 center of rotation 116. Additionally, to optimize any particular cycle, the wafer spin rate may be stopped or varied and the megasonic energy varied by changing any combination of the power setting to the transducers 120, the frequency or frequencies applied, and by pulsing. In one embodiment, the bracket 106 can rotate the wafer 110 during a stripping operation at an rpm of approximately between 10-200 and during the phase to remove the stripping chemicals, at greater than 200 rpm where a range of approximately between 250-6000 rpm is preferable.

Megasonic waves can first strike the wafer bottom side 125 where no devices, i.e. transistors, exist that could be damaged by the full force of the acoustic energy. Depending on the frequency or frequencies used, the megasonic energy may be dampened to a degree when passing through the circular plate 118 and wafer 110 to exit into the stripping solution 234 and 236 at the wafer top 116, i.e. device side.

A thin film of the stripping solution 234 and 236 may be all that is required on the wafer top surface 116 to strip the photoresist. The action of the megasonic energy on the wafer top surface 116 may be confined to a small volume (thin film) that contacts the photoresist that absorbs the sonic waves, and maintains useful cavitation.

In an embodiment, megasonic energy is applied to the rotating wafer 110 throughout the stripping process. Megasonic energy is generally defined as frequencies in the range of 400 kHz-8 MHz but may be higher. For stripping photoresist coatings, a frequency that is in the range of approximately 400-1000 kHz may be preferred. In addition, the frequencies applied are not limited to a single frequency. A combination of frequencies, such as, for example, 450 and 900 kHz may also be used to strip the photoresist.

After the photoresist stripping operation is complete, the wafer 110 can remain in the single wafer cleaning chamber 100 to be subjected to a cleaning and rinse cycle. In the cleaning process, an RCA-type cleaning, i.e. the RCA process and similar cleaning processes, may use the same nozzles 130 and 132 as was used in the stripping operation to be connected to common tubing by valves 140, 142, and 144. The cleaning operation may also make use of an etchant such as hydrofluoric acid (HF) having a concentration of 0.5% by weight of HF (not shown). The RCA-type cleaning process is commonly used and is well known to those skilled in the art. The RCA-type process may include a first standard clean (SC-1) cycle (NH₄OH+H₂O₂) 160, a rinse (deionized water ending with IPA vapor in N₂) 166, an SC-2 clean (HCl+H₂O₂) 162, a rinse (deionized water ending with IPA vapor in N₂) 166, and a dry cycle.

After the photoresist coating has been stripped, cleaned and rinsed, the two nozzles 130 and 132 that dispense the chemicals 134, 136, 160, 162, 164 can translate over the wafer 110 such as by pivot 142 so that the two nozzles 130 and 132 can move clear of the wafer 110 and wafer holding bracket 106 during wafer transfer.

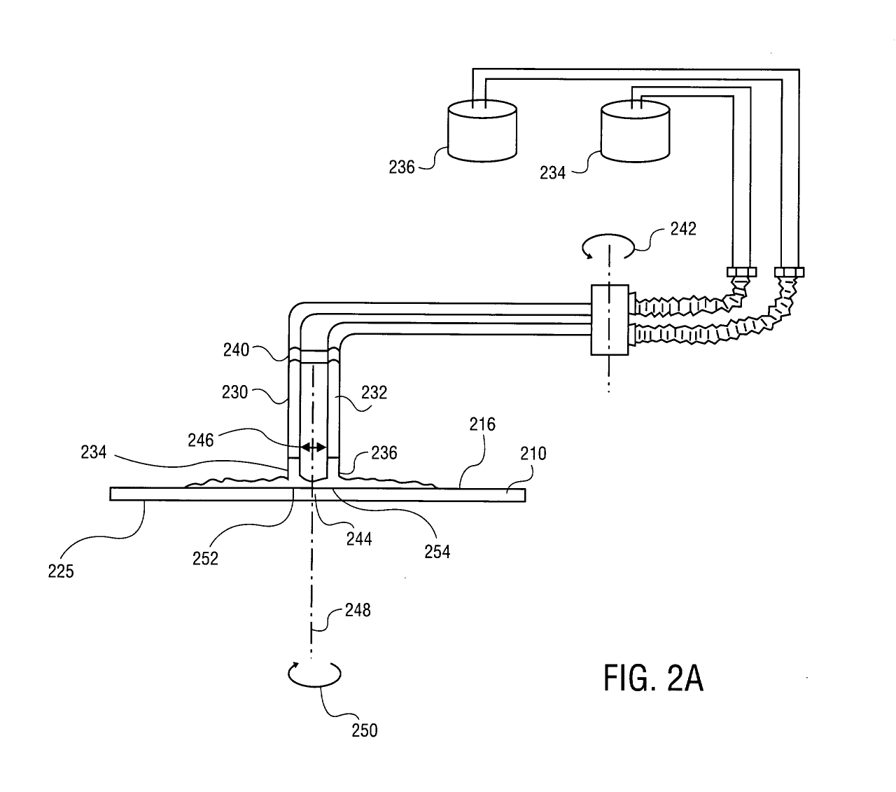

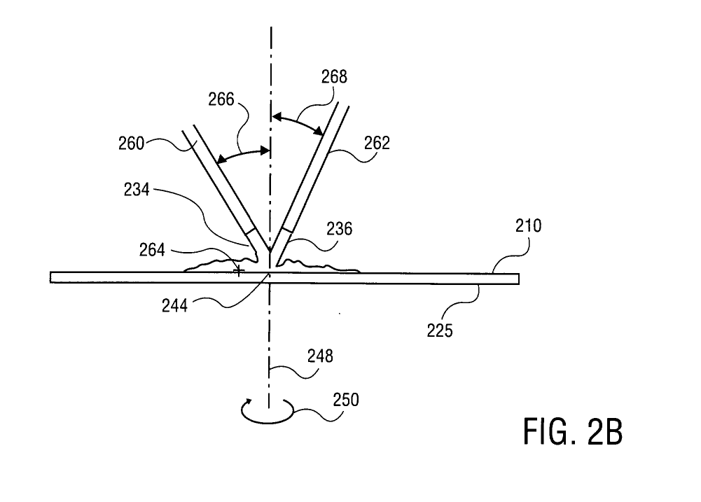

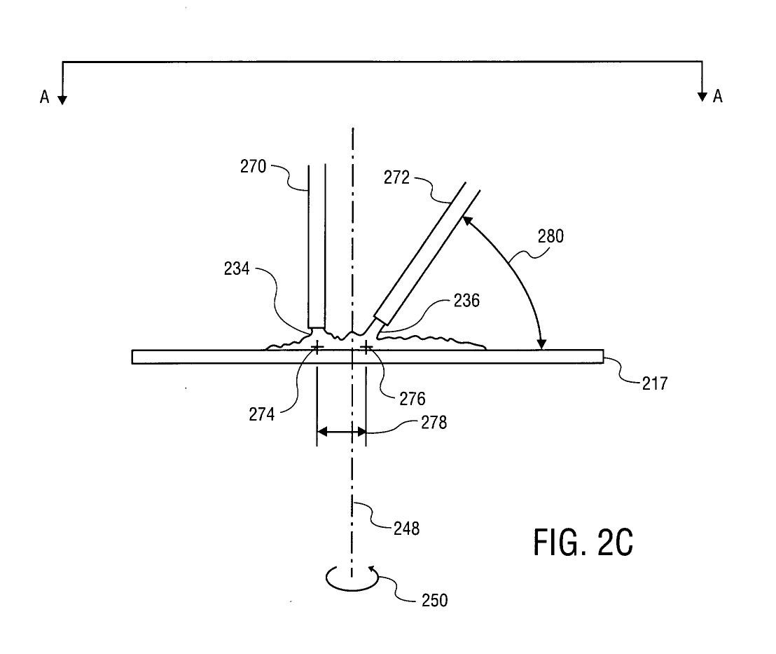

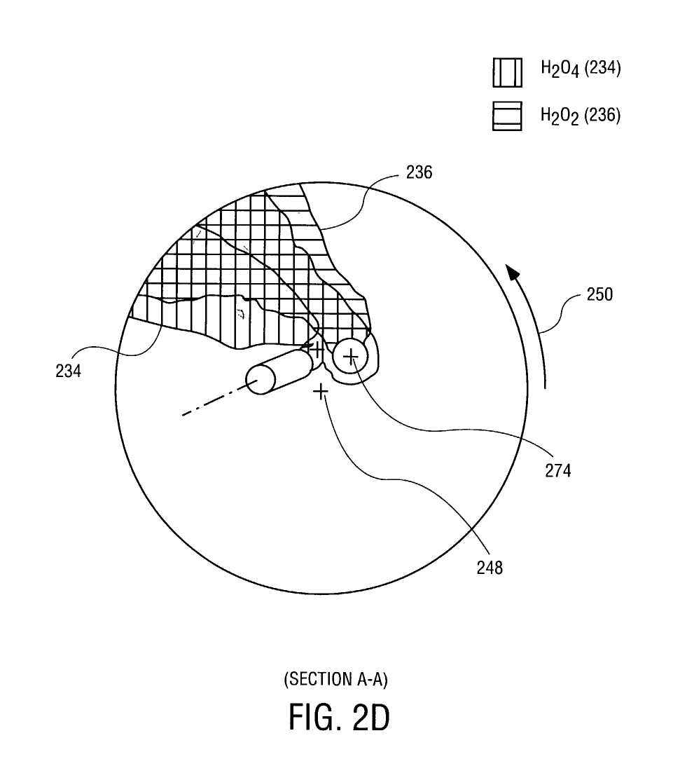

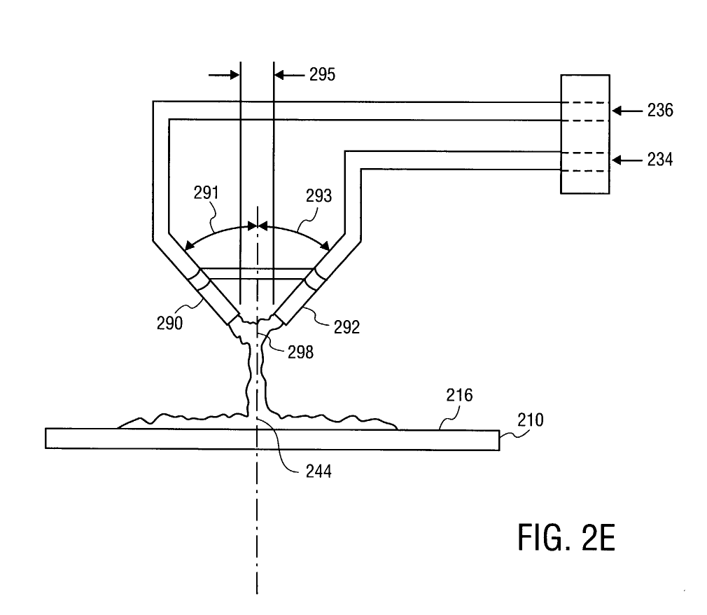

FIG. 2A is an illustration of one embodiment of two nozzles used to apply photoresist stripping chemicals onto a wafer surface. A first nozzle 230 can be connected to a source of H2SO4 (234) while a second nozzle 232 can be connected to a source of H2O2 (236). The two nozzles 230 and 232 can each pivot about a common centerline 242 and the two nozzles 230 and 232 can be fixedly attached 240 to pivot in unison. The two nozzles 230 and 232 can each dispense a liquid 234 or 236 onto the wafer top surface 216 and where the two nozzles 230 and 232 can be centered about the wafer 210 center of rotation 248. The two nozzles 230 and 232 can have an edge separation 246 that is approximately in the range of 0.15-1.5 inch. Mixing of the H2SO4 (234) with the H2O2 (236) can occur due to the proximity 246 of the chemical stream of H2SO4 (234) at a first location 252 with the chemical stream of H2O2 (236) at a second location 254. In one embodiment, the two nozzles can be separated (edge-to-edge) 246 by a distance that is in the range of approximately 0.1-0.25 inches. Mixing of the two chemicals 234 and 236 can be further enhanced by rotation 250 of the wafer 210 and by the application of megasonics to the wafer bottom side 225.

FIG. 2B is an illustration of an alternate embodiment for dispensing fluids through nozzles. In this embodiment, two nozzles 260 and 262 are angled 266 and 268 respectively such that both chemicals 234 and 236 contact the wafer 210 at the same location 244. The angle for the nozzles 260 and 262 can be the same, such as, for example, 45 degrees, or the angles can be different to optimize mixing by compensating for such factors as flow rates and the differing masses for the two chemicals 234 and 236. This common location 244 can be at the center of rotation 248 for the wafer 210 or, alternatively, the location can be approximately in the range of 0-1.0 inch off-center 264. As stated, mixing of the two chemicals 234 and 236 can be further enhanced by rotation 250 of the wafer 210 and by the application of megasonics to the wafer bottom side 225.

FIGS. 2C and 2D are illustrations of another alternate embodiment for the two nozzles. The two nozzles 270 and 272 can flow H2SO4 (234) and H2O2 (236) respectfully where the H2SO4 (234) is applied normal to the wafer 210 at a first location 274 and were the flow of H2O2 contacts the wafer at a second location 276 that is “downstream” of the H2SO4 (234) first location 274 relative to the direction of wafer rotation 250. The separation distance 278, between the H2SO4 (234) and H2O2 (236) contacting the wafer, can be in the range of approximately 0-1.5 inches. The angle 280 for the H2O2 nozzle 272 can be in the range of approximately 45-30 degrees from horizontal.

FIG. 2E is yet another alternate embodiment for the two nozzles. As shown in FIG. 2E, two nozzles 290 and 292 are angled 294 and 296 respectively, such that mixing of the chemicals 234 and 236 can begin above the wafer top surface 216. With angled nozzles 290 and 292, the flow of H2SO4 (234) and H2O2 (236) can impinge 298 prior to contact with the wafer 210. With mixing started above the wafer 210, and with further mixing occurring on the wafer 210, the overall mixing efficiency can be improved. The two nozzles 290 and 292 can be centered over the wafer center 244 and spaced 295 a distance that is in the range of approximately 0.10-0.50′ apart and where each nozzle 290 and 292 can be angled 291 and 293 respectively toward the other nozzle 290 and 292 and where each angle 291 and 293 can be approximately in the range of 20-60 degrees from vertical.

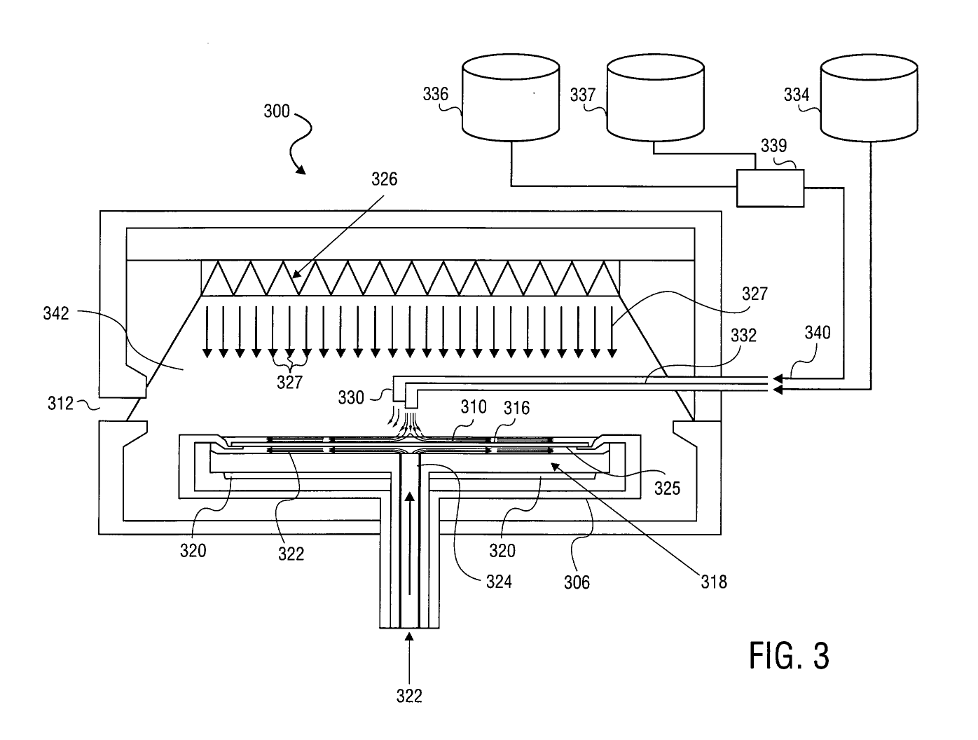

FIG. 3 is an alternate embodiment of a single wafer cleaning chamber where the H2O2 can be applied as a vapor. With less volume of H2O2 (336) required to be applied to the wafer 310 than H2SO4 (334), the H2O2 (336) may be diluted to increase the overall volume which can allow for a more uniform mixing of the two chemicals 334 and 336. Adding more water to the H2O2 (326) can add to the problems previously cited, and so, another method of dilution can be to create an H2O2 vapor 340, for example, with an inert gas 337 that can be mixed with the H2O2 (336). The H2O2 vapor 340 can be created, such as, for example, by bubbling the inert gas 337 through the H2O2 336 solution in a vapor mixing chamber 339. One example of an inert gas 337 that can be used is nitrogen (N2). As a vapor 340, the H2O2 (340) can still be applied through a first nozzle 330 and then directed toward a rotating wafer 310 along with the H2SO4 (334) from a second nozzle 332 directed toward the rotating wafer 310.

Alternate methods (not shown) for forming the H2O2 vapor can include a venturi design within a vaporizer chamber that can include an inert gas source to inject the inert gas into a fluid steam of H2O2 before the fluid stream passes out of the vaporizer. Using this venturi approach, a flow of H2O2 through a throat, which increases the flow rate locally will thereby reduce the fluid pressure at the throat. A small hole (injector port) is placed in the throat 354 and is attached to an inert gas source. As the fluid stream passes by the injector port, the inert gas is drawn into the lower pressure of the stream of H2O2. In another alternate, the inert gas may simply be injected into the fluid stream under sufficient pressure thereby avoiding the need for a venturi design.

The application of H2SO4 (334) and H2O2 (336) can be continuous or, alternately, the application of either or both the two chemicals can be pulsed. By pulsing, a brief, i.e. non-continuous, flow of the chemical 334 and/or 336 can occur where the duration of each pulse can provide a volume H2O2 (336) to react with a volume of H2SO4 (334). To obtain the total volume of each chemical 334 and 336 applied to the wafer 310, the duration and number of pulses is determined, and where this duration and number of pulses can be varied for each chemical 334 and 336. In this manner, a smaller volume of H2O2 (336) can in effect be mixed in with a larger volume of H2SO4 (334), by varying the pulse times and/or the number of pulses for the two chemicals 334 and 336.

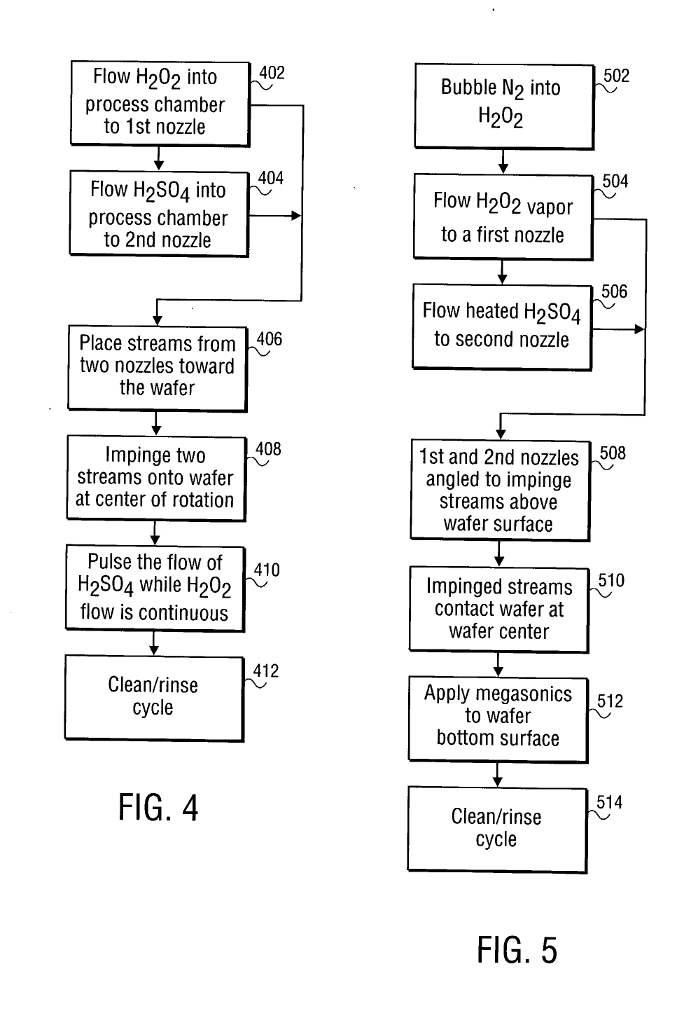

FIG. 4 is one embodiment of a flow diagram of a method for the application of H2SO4 and H2O2. The process cycle can use a single wafer cleaning chamber to remove a photoresist layer on a wafer. H2O2, at a temperature, can flow to a first nozzle in the single wafer process chamber (operation 402). H2SO4 can flow at a temperature to a second nozzle in the single wafer process chamber (operation 404). Angled first and second nozzles can impinge the flow of H2SO4 with the flow of H2O2 (operation 406) where the impinged flow can occur at a common point on the top surface of the wafer at the wafer center of rotation (operation 408). Flow of the H2SO4 can be pulsed while the flow of H2O2 can be continuous (operation 410). After flow of H2SO4 and H2O2 is complete, a wafer clean and rinse process such as an RCA-type clean can be initiated (operation 412).

FIG. 5 is an alternate embodiment of a flow diagram for the application of H2SO4 and H2O2 to remove a photoresist layer from a wafer. N2 and H2O2, each at a temperature, can initially flow into a vapor mixing chamber where the N2 can bubble into the H2O2 (operation 502). The resulting H2O2 vapor can then flow to a first nozzle in the single wafer process chamber (operation 504). H2SO4 can flow at a temperature to a second nozzle in the single wafer process chamber (operation 506). Angled first and second nozzles can mix the flow of H2SO4 with the flow of H2O2 at approximately 0.25 inch above the center of the wafer prior to contacting the wafer (operation 508). After impinging, the flow of mixed H2SO4 and H2O2 can contact the center of the wafer (operation 510). Apply megasonics to the wafer bottom surface during the flow of photoresist stripping chemicals onto the wafer top surface (operation 512). Once the removal of the photoresist coating is complete, a wafer cleaning and rinse process can be initiated (operation 514).

Thus a method and apparatus for removing coatings such as a photoresist layer from a wafer is described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method of stripping photoresist from a single wafer, comprising:
flowing H2SO4 toward a top surface of the wafer; and
flowing H2O2 toward the top surface of the wafer; wherein the H2SO4 reaches a first location and the H2O2 reaches a second location.

2. The method of claim 1, further comprising, applying megasonic energy to the wafer.

3. The method of claim 1, wherein the first location and the second location are the same location.

4. The method of claim 3, wherein the same location is above the top surface of the wafer.

5. The method of claim 3, wherein the same location is at the top surface of the wafer.

6. The method of claim 4, wherein the same location is at the center of rotation for the wafer.

7. The method of claim 1, wherein the first location and the second location are on the top surface of the wafer.

8. The method of claim 7, wherein the first location and the second location are centered about the wafer center of rotation.

9. The method of claim 8, wherein the first location and the second location are a distance of approximately in the range of 0.15-1.5 inch apart edge-to-edge.

10. The method of claim 1, wherein the H2O2 is at a temperature of approximately in the range of 25-90 degrees C.

11. The method of claim 1, wherein the H2SO4 is at a temperature of approximately in the range of 25-90 degrees C.

12. The method of claim 7, wherein the second location is downstream to the first location such.

13. The method of claim 1, wherein the H2SO4 is a concentrated solution.

14. The method of claim 13, wherein the H2O2 is an approximate 29% solution with water by weight.

15. The method of claim 14, wherein the H2SO4/H2O2 is applied at a ratio of approximately 4:1 by volume.

16. The method of claim 1, wherein the wafer is heated by heated deionized water contacting a bottom side of the wafer.

17. The method of claim 1, wherein the H2O2 is a vapor.

18. The method of claim 17, wherein the vapor is created with an inert gas.

19. The method of claim 18, where in the inert gas is N2.

20. The method of claim 1, wherein the H2SO4 is applied in pulses.

21. The method of claim 1, wherein the H2O2 is applied in pulses.

22. The method of claim 1, further comprising, performing a cleaning process on the wafer.

23. The method of claim 22, further comprising applying megasonic energy to the wafer bottom surface during the cleaning process.

24. The method of claim 22, wherein the cleaning process is an RCA-type cleaning process.

25. A single wafer cleaning chamber, comprising:
a rotatable wafer holding bracket;
a source of H2O2 connected to a first nozzle; and
a source of H2SO4 connected to a second nozzle, wherein the first nozzle and the second nozzle are capable of directing a liquid flow onto a wafer positioned in the rotatable wafer holding bracket.

26. The single wafer cleaning chamber of claim 25, further comprising:
a source of an inert gas; and
an H2O2 vapor mixing chamber connected between the source of H2O2 and the first nozzle.

27. The single wafer cleaning chamber of claim 25, wherein the first nozzle and the second nozzle are angled toward each other.

28. The single wafer cleaning chamber of claim 27, wherein the angled nozzles are capable of impinging a flow from the first nozzle with a flow from the second nozzle above the wafer top surface.

29. The single wafer cleaning chamber of clam 27, wherein the angled nozzles are capable of impinging a flow from the first nozzle with a flow from the second nozzle on the wafer top surface.

30. The single wafer cleaning chamber of claim 25, further comprising:
megasonic transducers attached to a circular plate, where the rotatable wafer holding bracket is capable of positioning a wafer above the circular plate.

31. The single wafer cleaning chamber of claim 25, further comprising a source of an SC-1 solution capable of connecting to the first nozzle and a source of an SC-2 solution capable of connecting to the second nozzle.
